(19) United States
(12) Patent Application Publication
(10) Pub. No.: US 2025/0156536 A1
(43) Pub. Date: May 15, 2025

(54) IN-VEHICLE RELAY DEVICE, IN-VEHICLE RELAY METHOD, AND IN-VEHICLE RELAY PROGRAM

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventors: Michihiro HETSUGI, Yokkaichi-Shi, Mie (JP); Yukihiro MIYASHITA, Yokkaichi-Shi, Mie (JP); Takuya KOBAYASHI, Yokkaichi-Shi, Mie (JP); Naoto KOBAYASHI, Yokkaichi-Shi, Mie (JP); Nobuhiro NAKAJIMA, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/834,473

(22) PCT Filed: Jan. 18, 2023
(86) PCT No.: PCT/JP2023/001272

§ 371 Date: Jul. 30, 2024

(30) Foreign Application Priority Data
Feb. 2, 2022 (JP) 2022-014574

(51) Int. Cl. G06F 21/55; H04L 12/40

(52) U.S. Cl. CPC G06F 21/554; H04L 12/40169; G06F 2221/032; H04L 2012/40215; H04L 2012/40273

(57) ABSTRACT

An in-vehicle relay device includes: a reception unit that receives a frame from an in-vehicle device, a first IC (Integrated Circuit) that performs relay processing of the frame received by the reception unit, and a second IC that is connected between the reception unit and the first IC and is configured to output the frame received from the reception unit to the first IC and output the frame received from the first IC to the outside of the in-vehicle relay device, and the second IC monitors the frame and stops output of the frame if the second IC determines that the frame is an unauthorized frame.

### CROSS-REFERENCE TO RELATED APPLICATIONS

This application is the U.S. national stage of PCT/JP2023/001272 filed on Jan. 18, 2023, which claims priority of Japanese Patent Application No. JP 2022-014574 filed on Feb. 2, 2022, the contents of which are incorporated herein.

### TECHNICAL FIELD

The present disclosure relates to an in-vehicle relay device, an in-vehicle relay method, and an in-vehicle relay program.

### BACKGROUND

International Publication No. 2019/225258 discloses the following abnormality detection device. That is, the abnormality detection device is an abnormality detection device capable of communicating with one or more communication devices respectively connected to one or more electronic control devices for controlling a mobile body via a network in a network system mounted in the mobile body, and includes: an abnormal frame detection unit that detects an abnormal frame, which is an abnormal data frame transmitted from the electronic control device to the network via the communication device; a communication unit that transmits to the communication device an abnormality request frame for requesting a response from the communication device that transmitted the detected abnormal frame, and receives from the communication device an abnormality response frame indicating the transmission source of the abnormal frame generated by the communication device based on the abnormality request frame; a network abnormality determination unit that calculates an abnormal communication device count indicating the number of communication devices that transmitted the abnormality response frame based on the received abnormality response frame, determines that the network system is in a first abnormal state if the abnormal communication device count is 0, and determines that the network system is in a second abnormal state if the abnormal communication device count is not 0; and a network abnormality handling unit that handles the first abnormal state or the second abnormal state if the network abnormality determination unit determines that the network system is in the first abnormal state or the second abnormal state.

In the case of performing processing for detecting an unauthorized frame and relay processing are performed in an in-vehicle relay device, the processing load on the in-vehicle relay device increases, and a communication delay may occur.

The present disclosure has been made to solve the above-mentioned problems, and aims to provide an in-vehicle relay device, an in-vehicle relay method, and an in-vehicle relay program that are capable of improving security while suppressing a communication delay in an in-vehicle network.

### SUMMARY

Conventionally, a relay device that performs relay processing in an in-vehicle network has been developed.

An in-vehicle relay apparatus according to the present disclosure includes: a reception unit configured to receive a frame from an in-vehicle device; a first IC (Integrated Circuit) configured to perform relay processing of the frame received from the reception unit; and a second IC that is connected between the reception unit and the first IC and is configured to output the frame received from the reception unit to the first IC and output the frame received from the first IC to the outside of the in-vehicle device, in which the second IC monitors the frame and stops output of the frame if the second IC determines that the frame is an unauthorized frame.

An in-vehicle relay method according to the present disclosure is an in-vehicle relay method for an in-vehicle relay device including a reception unit, a first IC configured to perform relay processing of a frame received by the reception unit, and a second IC that is connected between the reception unit and the first IC and is configured to output the frame received from the reception unit to the first IC and output the frame received from the first IC to the outside of the in-vehicle relay device, the in-vehicle relay method including: a step of receiving a frame from an in-vehicle device; and a step of the second IC monitoring the frame and stopping output of the frame if the second IC determines that the frame is an unauthorized frame.

An in-vehicle relay program according to the present disclosure is an in-vehicle relay program to be used in an in-vehicle relay device configured to receive a frame from an in-vehicle device, the program being for causing a computer to function as: a reception unit configured to receive a frame from an in-vehicle device; a first IC configured to perform relay processing of the frame received from the reception unit; and a second IC that is connected between the reception unit and the first IC and is configured to output the frame received from the reception unit to the first IC and output the frame received from the first IC to the outside of the in-vehicle device, in which the second IC monitors the frame and stops output of the frame if the second IC determines that the frame is an unauthorized frame.

One aspect of the present disclosure can not only be realized as an in-vehicle relay device including such a characteristic processing unit, but can also be realized as a semiconductor integrated circuit that realizes part or all of the in-vehicle relay device, or as an in-vehicle communication system that includes the in-vehicle relay device.

### Advantageous Effects of the Disclosure

According to the present disclosure, it is possible to improve security while suppressing a communication delay in an in-vehicle network.

### BRIEF DESCRIPTION OF DRAWINGS

FIG. 1 is a diagram illustrating a configuration of an in-vehicle communication system according to an embodiment of the present disclosure.

FIG. 2 is a diagram illustrating an example of a CAN frame transmitted by an in-vehicle ECU in the in-vehicle communication system according to the embodiment of the present disclosure.

FIG. 3 is a diagram illustrating a configuration of an in-vehicle relay device according to the embodiment of the present disclosure.

FIG. 4 is a diagram illustrating an example of a timing chart of relay processing in the in-vehicle communication system according to the embodiment of the present disclosure.

FIG. 5 is a diagram illustrating another example of a timing chart of relay processing in the in-vehicle communication system according to the embodiment of the present disclosure.

FIG. 6 is a flowchart illustrating an example of an operation procedure for when the in-vehicle relay device according to the embodiment of the present disclosure performs relay processing and detection processing.

FIG. 7 is a flowchart defining another example of an operation procedure for when the in-vehicle relay device according to the embodiment of the present disclosure performs relay processing and detection processing.

FIG. 8 is a diagram illustrating a configuration of an in-vehicle communication system according to Variation 1 of the embodiment of the present disclosure.

FIG. 9 is a diagram illustrating a configuration of an in-vehicle relay device according to Variation 1 of the embodiment of the present disclosure.

FIG. 10 is a diagram illustrating a configuration of an in-vehicle communication system according to Variation 2 of the embodiment of the present disclosure.

FIG. 11 is a diagram illustrating an example of a timing chart of relay processing in an in-vehicle communication system according to Variation 2 of the embodiment of the present disclosure.

FIG. 12 is a flowchart illustrating an example of an operation procedure for when an in-vehicle relay device according to Variation 2 of the embodiment of the present disclosure performs relay processing and detection processing.

### DETAILED DESCRIPTION OF PREFERRED EMBODIMENTS

First, contents of embodiments of the present disclosure will be listed and described.

An in-vehicle relay device according to an embodiment of the present disclosure includes: a reception unit configured to receive a frame from an in-vehicle device; a first IC (Integrated Circuit) configured to perform relay processing of the frame received from the reception unit; and a second IC that is connected between the reception unit and the first IC and is configured to output the frame received from the reception unit to the first IC and output the frame received from the first IC to the outside of the in-vehicle device, in which the second IC monitors the frame and stops output of the frame if the second IC determines that the frame is an unauthorized frame.

In this way, by using a configuration in which the second IC that performs detection processing is included in addition to the first IC that performs relay processing, the in-vehicle relay device of the present disclosure can distribute the processing load in the in-vehicle relay device and reduce the processing load of the first IC compared to a configuration in which the first IC performs relay processing and detection processing. Also, the in-vehicle relay device of the present disclosure can prevent the in-vehicle device that is the relay destination from receiving an unauthorized frame, thereby further improving security. Accordingly, it is possible to improve security while suppressing a communication delay in the in-vehicle network.

The second IC may monitor the frame received from the reception unit and stop output of the frame to the first IC if the second IC determines that the frame is an unauthorized frame.

With this configuration, it is possible to prevent the first IC from receiving an unauthorized frame. Also, by reducing the number of frames received by the first IC, the processing load on the first IC can be reduced.

The second IC may monitor the frame received from the first IC and stop output of the frame to the outside of the in-vehicle relay device if the second IC determines that the frame is an unauthorized frame.

With this configuration, compared to a configuration in which the output of the frame to the first IC is stopped, the first IC can recognize that the frame has been received by the reception unit, whereby it is possible to continue stable communication with an external device.

The first IC may be a processor, and the second IC may have a circuit including a PLD (Programmable Logic Device).

With this configuration, a manufacturer or user of the in-vehicle relay device according to the present disclosure can realize an in-vehicle relay device with improved security without upgrading to a high-performance processor, by adding the PLD to an in-vehicle relay device including an existing processor that performs relay processing.

The second IC may have a circuit including an FPGA (Field Programmable Gate Array).

With this configuration, the manufacturer or user of the in-vehicle relay device of the present disclosure can more flexibly change the content of the detection processing performed by the second IC.

The in-vehicle relay device may further include a plurality of communication ports, the first IC may perform the relay processing of a plurality of the frames received by the reception unit via the respective plurality of communication ports, and the second IC may monitor the plurality of frames received by the reception unit via the respective plurality of communication ports.

With this configuration, the in-vehicle relay device of the present disclosure can improve security while suppressing communication delay to an allowable level, even if the relay processing targets are widespread and the processing load of the relay processing is large.

The reception unit may receive the frame conforming to a CAN (Controller Area Network) or a CAN FD (CAN with Flexible Data rate) standard and output the received frame to the second IC, and the second IC may perform determination of the unauthorized frame based on an ID (Identifier) stored in the frame.

With this configuration, the in-vehicle relay device of the present disclosure can more quickly perform determination of the unauthorized frame, and therefore it is possible to shorten the relay delay time that occurs due to performing detection of the unauthorized frame. Also, for example, if the first IC receives a detection result from the second IC, the time required for the first IC to perform processing for receiving the detection result is shorter than the time required for the detection processing. Accordingly, compared to a configuration in which detection processing is performed in the first IC, the in-vehicle relay device according to the present disclosure can discard an unauthorized frame or the like in the first IC based on the detection result, while suppressing the occurrence of relay delay time.

The reception unit may receive the frame conforming to a CAN or a CAN FD standard and output the received frame to the second IC, and the second IC may perform determination of the unauthorized frame based on a DLC (Data Length Code) stored in the frame.

With this configuration, the in-vehicle relay device of the present disclosure can more quickly perform determination of the unauthorized frame, and therefore it is possible to shorten the relay delay time that occurs due to performing determination of the unauthorized frame. Also, for example, if the first IC receives a detection result from the second IC, the time required for the first IC to perform processing for receiving the detection result is shorter than the time required for the detection processing. Accordingly, compared to a configuration in which detection processing is performed in the first IC, the in-vehicle relay device according to the present disclosure can discard an unauthorized frame or the like in the first IC based on the detection result, while suppressing the occurrence of relay delay time.

The in-vehicle relay device may further include a third IC configured to monitor the frame received by the reception unit, and if the third IC determines that the frame is an unauthorized frame, notify the first IC of a detection result indicating that the unauthorized frame has been detected, and the first IC may stop the relay processing of the unauthorized frame based on the detection result notified from the third IC.

With this configuration, an unauthorized frame can be detected more reliably. Also, the processing load relating to frame monitoring can be distributed between the second IC and the third IC.

An in-vehicle relay method according to an embodiment of the present disclosure is an in-vehicle relay method for an in-vehicle relay device including a reception unit, a first IC configured to perform relay processing of a frame received by the reception unit, and a second IC that is connected between the reception unit and the first IC and is configured to output the frame received from the reception unit to the first IC and output the frame received from the first IC to the outside of the in-vehicle relay device, the in-vehicle relay method including: a step of receiving a frame from an in-vehicle device; and a step of the second IC monitoring the frame and stopping output of the frame if the second IC determines that the frame is an unauthorized frame.

In this way, in the in-vehicle relay method according to the present disclosure, by using a configuration in which the second IC that performs detection processing is included in addition to the first IC that performs relay processing, it is possible to distribute the processing load in the in-vehicle relay device and reduce the processing load on the first IC compared to a configuration in which the first IC performs relay processing and detection processing. Also, the in-vehicle relay method of the present disclosure can prevent the in-vehicle device that is the relay destination from receiving an unauthorized frame, thereby further improving security. Accordingly, it is possible to improve security while suppressing a communication delay in the in-vehicle network.

Regarding an in-vehicle relay device according to an embodiment of the present disclosure, a relay program is an in-vehicle relay program to be used in an in-vehicle relay device configured to receive a frame from an in-vehicle device, the program being for causing a computer to function as: a reception unit configured to receive a frame from an in-vehicle device; a first IC configured to perform relay processing of the frame received from the reception unit; and a second IC that is connected between the reception unit and the first IC and is configured to output the frame received from the reception unit to the first IC and output the frame received from the first IC to the outside of the in-vehicle device, in which the second IC monitors the frame and stops output of the frame if the second IC determines that the frame is an unauthorized frame.

In this way, with the in-vehicle relay program according to the present disclosure, by using a configuration in which the second IC that performs detection processing is included in addition to the first IC that performs relay processing, it is possible to distribute the processing load in the in-vehicle relay device and reduce the processing load on the first IC compared to a configuration in which the first IC performs relay processing and detection processing. Also, the in-vehicle relay program of the present disclosure can prevent the in-vehicle device that is the relay destination from receiving an unauthorized frame, thereby further improving security. Accordingly, it is possible to improve security while suppressing a communication delay in the in-vehicle network.

Hereinafter, an embodiment of the present disclosure will be described with reference to the drawings. Note that the same or corresponding parts in the drawings are denoted by the same reference signs and description thereof is not repeated. Also, at least some of the embodiments described below may be combined as appropriate.

### Configuration and Basic Operation

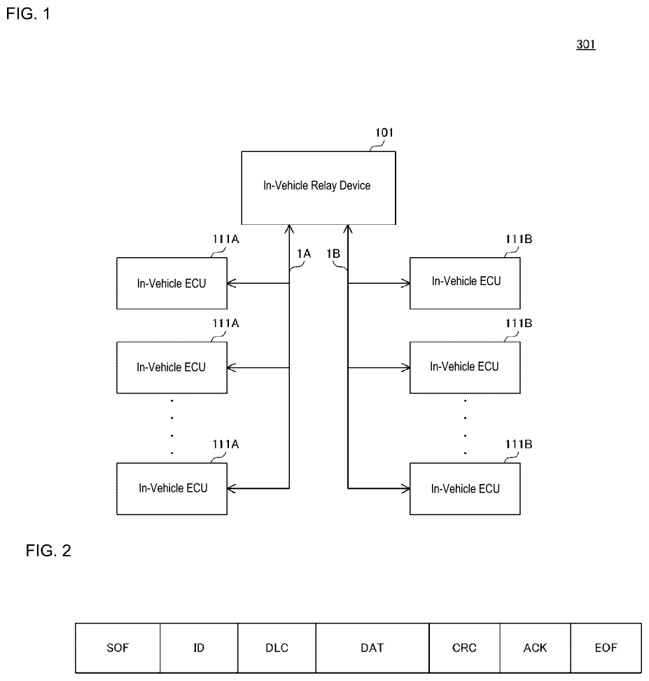

FIG. 1 is a diagram showing a configuration of an in-vehicle communication system according to an embodiment of the present disclosure. With reference to FIG. 1, an in-vehicle communication system 301 includes an in-vehicle relay device 101, a plurality of in-vehicle ECUs (Electronic Control Units) 111A, and a plurality of in-vehicle ECUs 111B. The in-vehicle ECUs 111A and 111B are examples of in-vehicle devices.

The plurality of in-vehicle ECUs 111A are connected to the in-vehicle relay device 101 via a bus 1A conforming to the CAN (registered trademark) standard. The plurality of in-vehicle ECUs 111B are connected to the in-vehicle relay device 101 via a bus 1B conforming to the CAN standard.

The in-vehicle ECUs 111A and 111B transmit and receive CAN frames, which are frames conforming to the CAN standard.

FIG. 2 is a diagram illustrating an example of a CAN frame transmitted by an in-vehicle ECU in the in-vehicle communication system according to the embodiment of the present disclosure. Referring to FIG. 2, a CAN frame has a SOF (Start Of Frame) field, an ID field, a DLC field, a data field (hereinafter also referred to as a DAT field), a CRC (Cyclic Redundancy Check) field, an ACK field, and an EOF field, in the stated order.

The in-vehicle ECUs 111A periodically or irregularly generate CAN frames in which data to be transmitted to the other in-vehicle ECUs 111A and the in-vehicle ECUs 111B is stored in a DAT field, and transmit the generated CAN frames to the other in-vehicle ECUs 111A and the in-vehicle relay device 101 via the bus 1A.

Also, the in-vehicle ECUs 111B periodically or irregularly generate CAN frames in which data to be transmitted to the in-vehicle ECUs 111A and the other in-vehicle ECUs 111B is stored in a DAT field, and transmit the generated CAN frames to the other in-vehicle ECUs 111B and the in-vehicle relay device 101 via the bus 1B.

The in-vehicle relay device 101 can relay CAN frames received from the in-vehicle ECUs 111A via the bus 1A to the in-vehicle ECUs 111B. Also, the in-vehicle relay device 101 can relay CAN frames received from the in-vehicle ECUs 111B via the bus 1B to the in-vehicle ECUs 111A.

### In-Vehicle Relay Device

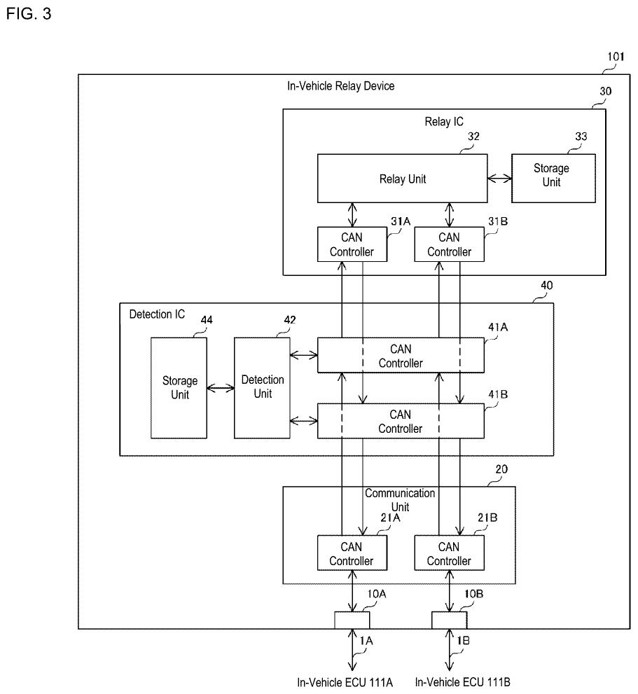

FIG. 3 is a diagram illustrating a configuration of an in-vehicle relay device according to an embodiment of the present disclosure. Referring to FIG. 3, the in-vehicle relay device 101 includes a plurality of communication ports 10, a communication unit 20, a relay IC 30, and a detection IC 40. The detection IC 40 is connected between the communication unit 20 and the relay IC 30. The communication unit 20 is an example of a reception unit. The relay IC 30 is an example of a first IC. The detection IC 40 is an example of a second IC. For example, the communication unit 20, the relay IC 30, and the detection IC 40 are connected to each other via a conductive pattern on a substrate.

As an example, the in-vehicle relay device 101 includes communication ports 10A and 10B, which are the communication ports 10. The bus 1A is connected to the communication port 10A. The bus 1B is connected to the communication port 10B.

The communication unit 20 includes CAN transceivers 21A and 21B. Hereinafter, each of the CAN transceivers 21A and 21B will also be referred to as a CAN transceiver 21.

The relay IC 30 includes CAN controllers 31A and 31B, a relay unit 32, and a storage unit 33. The storage unit 33 is, for example, a non-volatile memory. Hereinafter, each of the CAN controllers 31A and 31B will also be referred to as a CAN controller 31. For example, the relay IC 30 is a processor. As an example, the relay IC 30 is a microcontroller.

The detection IC 40 includes CAN controllers 41A and 41B, a detection unit 42, and a storage unit 44. The storage unit 44 is, for example, a non-volatile memory. Hereinafter, each of the CAN controllers 41A and 41B will also be referred to as a CAN controller 41. For example, the detection IC 40 has a circuit including a PLD. More specifically, the detection IC 40 has a circuit including an FPGA, an ASIC (Application Specific Integrated Circuit), or a CPLD (Complex Programmable Logic Device).

The communication unit 20 receives CAN frames from the in-vehicle ECUs 111A and 111B. More specifically, the CAN transceiver 21A receives CAN frames from the in-vehicle ECUs 111A via the communication port 10A. The CAN transceiver 21A outputs the received CAN frames to the detection IC 40. Also, the CAN transceiver 21B receives CAN frames from the in-vehicle ECUs 111B via the communication port 10B. The CAN transceiver 21B outputs the received CAN frames to the detection IC 40.

The detection IC 40 outputs the CAN frames received from the communication unit 20 to the relay IC 30. More specifically, the CAN controller 41A in the detection IC 40 receives the CAN frames from the CAN transceiver 21A in the communication unit 20 and outputs the received CAN frames to the CAN controller 31A in the relay IC 30. Also, the CAN controller 41B in the detection IC 40 receives the CAN frames from the CAN transceiver 21B in the communication unit 20 and outputs the received CAN frames to the CAN controller 31B in the relay IC 30.

### Relay Processing

The relay IC 30 relays the CAN frames received by the communication unit 20. For example, the relay IC 30 relays a plurality of CAN frames received by the communication unit 20 via the plurality of communication ports 10, respectively. Specifically, the relay IC 30 performs relay processing of the CAN frames received by the communication unit 20 via the communication port 10A, and performs relay processing of the CAN frames received by the communication unit 20 via the communication port 10B.

The relay IC 30 acquires the CAN frames received by the communication unit 20 and performs relay processing.

More specifically, the CAN controller 31A acquires a CAN frame received by the CAN transceiver 21A in the communication unit 20. Specifically, the CAN controller 31A detects the beginning of a CAN frame by receiving an SOF in the CAN frame received from the CAN controller 41A, and starts the processing for acquiring the CAN frame. Then, the CAN controller 31A receives an EOF in the CAN frame received from the CAN controller 41A, determines that the processing for acquiring the CAN frame is complete, and outputs the acquired CAN frame to the relay unit 32.

The relay unit 32 receives a CAN frame from the CAN controller 31A and performs reception checking processing for checking the content of the received CAN frame. Specifically, in the reception checking processing, the relay unit 32 uses, for example, the information stored in the CRC field to check whether or not the CAN frame to be relayed has been received normally.

Then, when the reception checking processing is complete, the relay unit 32 performs relay processing of the CAN frame to be relayed. Specifically, the relay unit 32 outputs the CAN frame to be relayed that was received from the CAN controller 31A, to the CAN controller 31B.

The CAN controller 31B receives the CAN frame from the relay unit 32 and outputs the received CAN frame to the detection IC 40.

The detection IC 40 outputs the CAN frame received from the relay IC 30 to the outside of the in-vehicle relay device 101. More specifically, the CAN controller 41B in the detection IC 40 receives a CAN frame from the CAN controller 31B in the relay IC 30, and outputs the received CAN frame to the in-vehicle ECUs 111B via the communication unit 20, the communication port 10B, and the bus 1B.

Also, the CAN controller 31B acquires the CAN frame received by the CAN transceiver 21B in the communication unit 20. Specifically, the CAN controller 31B detects the beginning of the CAN frame by receiving an SOF in the CAN frame received from the CAN controller 41B, and starts the processing for acquiring the CAN frame. Then, the CAN controller 31B receives an EOF in the CAN frame received from the CAN controller 41B, determines that the processing for acquiring the CAN frame is complete, and outputs the acquired CAN frame to the relay unit 32.

The relay unit 32 receives a CAN frame from the CAN controller 31B and performs reception checking processing for checking the content of the received CAN frame.

Then, when the reception checking processing is complete, the relay unit 32 performs relay processing of the CAN frame to be relayed. Specifically, the relay unit 32 outputs the CAN frame to be relayed that was received from the CAN controller 31B, to the CAN controller 31A.

The CAN controller 31A receives the CAN frame from the relay unit 32 and outputs the received CAN frame to the detection IC 40.

The detection IC 40 outputs the CAN frame received from the relay IC 30 to the outside of the in-vehicle relay device 101. More specifically, the CAN controller 41A in the detection IC 40 receives a CAN frame from the CAN controller 31A in the relay IC 30, and outputs the received CAN frame to the in-vehicle ECUs 111A via the communication unit 20, the communication port 10A, and the bus 1A.

### Detection Processing

The detection IC 40 monitors the CAN frame and performs detection processing for determining whether or not the CAN frame is an unauthorized frame. If the detection IC 40 determines that the CAN frame is an unauthorized frame, the detection IC 40 stops outputting the CAN frame. For example, the detection IC 40 monitors a plurality of CAN frames received by the communication unit 20 via the plurality of communication ports 10, respectively. More specifically, the detection IC 40 monitors the CAN frames received by the communication unit 20 via the communication port 10A, and monitors the CAN frames received by the communication unit 20 via the communication port 10B.

### Example 1 of Detection Processing

The detection IC 40 monitors the CAN frames received from the communication unit 20, and if the detection IC 40 determines that the CAN frames are unauthorized frames, the detection IC 40 stops output of the CAN frames to the relay IC 30. Example 1 of the detection processing corresponds to the function of an IDS (Intrusion Detection System), for example.

### Specific Example 1-1

The detection IC 40 performs determination of an unauthorized frame based on the ID stored in the ID field of the CAN frame.

More specifically, the CAN controller 41A receives a CAN frame from a CAN transceiver 21 in the communication unit 20, acquires the ID stored in the ID field of the received CAN frame, and outputs received frame information indicating the acquired ID to the detection unit 42. The CAN controller 41A suspends output of the CAN frame to the relay IC 30 until the CAN controller 41A receives notification of the determination result from the detection unit 42.

The detection unit 42 performs detection processing based on the received frame information received from the CAN controller 41A. More specifically, the detection unit 42 determines whether or not the CAN frame received by the communication unit 20 is an unauthorized frame based on the received frame information that was received.

For example, the storage unit 44 stores an ID list indicating a list of IDs stored in authorized CAN frames that are to undergo relay processing in the in-vehicle relay device 101.

The detection unit 42 compares the ID indicated in the received frame information received from the CAN controller 41A and the ID list in the storage unit 44.

If the ID list includes an ID that matches the ID indicated in the received frame information received from the CAN controller 41A, the detection unit 42 determines that the CAN frame received by the CAN controller 41A from the CAN transceiver 21 is not an unauthorized frame, and notifies the CAN controller 41A of the determination result.

If the CAN controller 41A receives notification from the detection unit 42 of the determination result that the CAN frame is not an unauthorized frame, the CAN controller 41A outputs the CAN frame, the output of which had been suspended, to the relay IC 30.

On the other hand, if the ID list does not include an ID that matches the ID indicated by the received frame information received from the CAN controller 41A, the detection unit 42 determines that the CAN frame received by the CAN controller 41A from the CAN transceiver 21 is an unauthorized frame, and notifies the CAN controller 41A of the determination result.

If the CAN controller 41A receives notification from the detection unit 42 of the determination result that the CAN frame is an unauthorized frame, the CAN controller 41A discards the CAN frame, the output of which had been suspended, without outputting the CAN frame to the relay IC 30.

### Specific Example 1-2

The detection IC 40 performs determination of an unauthorized frame based on the DLC stored in the DLC field of the CAN frame.

More specifically, the CAN controller 41A receives a CAN frame from a CAN transceiver 21 in the communication unit 20, acquires the DLC stored in the DLC field of the received CAN frame, and outputs received frame information indicating the acquired DLC to the detection unit 42. The CAN controller 41A suspends output of the CAN frame to the relay IC 30 until the CAN controller 41A receives notification of the determination result from the detection unit 42.

For example, the storage unit 44 stores a DLC list indicating a list of DLCs stored in authorized CAN frames that are to be subjected to relay processing in the in-vehicle relay device 101.

The detection unit 42 compares the DLC indicated by the received frame information received from the CAN controller 41A with the DLC list in the storage unit 44.

If the DLC list includes a DLC that matches the DLC indicated by the received frame information received from the CAN controller 41A, the detection unit 42 determines that the CAN frame received by the CAN controller 41A from the CAN transceiver 21 is not an unauthorized frame, and notifies the CAN controller 41A of the determination result.

If the CAN controller 41A receives notification from the detection unit 42 of the determination result that the CAN frame is not an unauthorized frame, the CAN controller 41A outputs the CAN frame, the output of which had been suspended, to the relay IC 30.

On the other hand, if the DLC list does not include a DLC that matches the DLC indicated by the received frame information received from the CAN controller 41A, the detection unit 42 determines that the CAN frame received by the CAN controller 41A from the CAN transceiver 21 is an unauthorized frame, and notifies the CAN controller 41A of the determination result.

If the CAN controller 41A receives notification from the detection unit 42 of the determination result that the CAN frame is an unauthorized frame, the CAN controller 41A discards the CAN frame, the output of which had been suspended, without outputting the CAN frame to the relay IC 30.

### Specific Example 1-3

The detection IC 40 performs determination of an unauthorized frame based on the data stored in the DAT field of the CAN frame.

More specifically, the CAN controller 41A receives a CAN frame from a CAN transceiver 21 in the communication unit 20, acquires the data stored in the DAT field of the received CAN frame, and outputs received frame information indicating the acquired data to the detection unit 42. The CAN controller 41A suspends output of the CAN frame to the relay IC 30 until the CAN controller 41A receives notification of the determination result from the detection unit 42.

For example, the storage unit 44 stores a numerical value list indicating appropriate numerical value ranges of data stored in authorized CAN frames that are to undergo relay processing in the in-vehicle relay device 101.

The detection unit 42 compares the value of the data indicated by the received frame information received from the CAN controller 41A with the numerical value range indicated by the numerical value list in the storage unit 44.

For example, if the value of the data indicated by the received frame information received from the CAN controller 41A is included in the numerical value range indicated by the numerical value list, the detection unit 42 determines that the CAN frame received by the CAN controller 41A from the CAN transceiver 21 is not an unauthorized frame, and notifies the CAN controller 41A of the determination result.

If the CAN controller 41A receives notification from the detection unit 42 of the determination result that the CAN frame is not an unauthorized frame, the CAN controller 41A outputs the CAN frame, the output of which had been suspended, to the relay IC 30.

On the other hand, if the value of the data indicated by the received frame information received from the CAN controller 41A is not included in the numerical value range indicated by the numerical value list, the detection unit 42 determines that the CAN frame received by the CAN controller 41A from the CAN transceiver 21 is an unauthorized frame, and notifies the CAN controller 41A of the determination result.

If the CAN controller 41A receives notification from the detection unit 42 of the determination result that the CAN frame is an unauthorized frame, the CAN controller 41A discards the CAN frame, the output of which had been suspended, without outputting the CAN frame to the relay IC 30.

### Example 2 of Detection Processing

The detection IC 40 monitors the CAN frame received from the relay IC 30, and if the detection IC 40 determines that the CAN frame is an unauthorized frame, the detection IC 40 stops output of the CAN frame to the outside of the in-vehicle relay device 101. Example 2 of the detection processing corresponds to the function of an IPS (Intrusion Prevention System).

### Specific Example 2-1

The detection IC 40 performs determination of an unauthorized frame based on the ID stored in the ID field of the CAN frame.

More specifically, the CAN controller 41B receives a CAN frame from a CAN controller 31 in the relay IC 30, acquires the ID stored in the ID field of the received CAN frame, and outputs received frame information indicating the acquired ID to the detection unit 42. The CAN controller 41B suspends output of the CAN frame to the in-vehicle ECUs 111 until the CAN controller 41B receives notification of the determination result from the detection unit 42.

For example, the detection unit 42 compares the ID indicated in the received frame information received from the CAN controller 41B with the ID list in the storage unit 44.

If the ID list includes an ID that matches the ID indicated in the received frame information received from the CAN controller 41B, the detection unit 42 determines that the CAN frame received by the CAN controller 41B from the CAN controller 31 is not an unauthorized frame, and notifies the CAN controller 41B of the determination result.

If the CAN controller 41B receives notification from the detection unit 42 of the determination result that the CAN frame is not an unauthorized frame, the CAN controller 41B outputs the CAN frame, the output of which had been suspended, to the in-vehicle ECUs 111 via the communication unit 20, the communication ports 10, and the buses 1.

On the other hand, if the ID list does not include an ID that matches the ID indicated by the received frame information received from the CAN controller 41B, the detection unit 42 determines that the CAN frame received by the CAN controller 41B from the CAN controller 31 is an unauthorized frame, and notifies the CAN controller 41B of the determination result.

If the CAN controller 41B receives notification from the detection unit 42 of the determination result that the CAN frame is an unauthorized frame, the CAN controller 41B discards the CAN frame, the output of which had been suspended, without outputting the CAN frame to the in-vehicle ECUs 111.

### Specific Example 1-2

The detection IC 40 performs determination of an unauthorized frame based on the DLC stored in the DLC field of the CAN frame.

More specifically, the CAN controller 41B receives a CAN frame from a CAN controller 31 in the relay IC 30, acquires the DLC stored in the DLC field of the received CAN frame, and outputs received frame information indicating the acquired DLC to the detection unit 42. The CAN controller 41B suspends output of the CAN frame to the in-vehicle ECUs 111 until the CAN controller 41B receives notification of the determination result from the detection unit 42.

For example, the detection unit 42 compares the ID indicated in the received frame information received from the CAN controller 41B with the ID list in the storage unit 44.

If the DLC list includes a DLC that matches the DLC indicated by the received frame information received from the CAN controller 41B, the detection unit 42 determines that the CAN frame received by the CAN controller 41B from the CAN controller 31 is not an unauthorized frame, and notifies the CAN controller 41B of the determination result.

If the CAN controller 41B receives notification from the detection unit 42 of the determination result that the CAN frame is not an unauthorized frame, the CAN controller 41B outputs the CAN frame, the output of which had been suspended, to the in-vehicle ECUs 111 via the communication unit 20, the communication ports 10, and the buses 1.

On the other hand, if the DLC list does not include a DLC that matches the DLC indicated by the received frame information received from the CAN controller 41B, the detection unit 42 determines that the CAN frame received by the CAN controller 41B from the CAN controller 31 is an unauthorized frame, and notifies the CAN controller 41B of the determination result.

If the CAN controller 41B receives notification from the detection unit 42 of the determination result that the CAN frame is an unauthorized frame, the CAN controller 41B discards the CAN frame, the output of which had been suspended, without outputting the CAN frame to the in-vehicle ECUs 111.

### Specific Example 2-3

The detection IC 40 performs determination of an unauthorized frame based on the data stored in the DAT field of the CAN frame.

More specifically, the CAN controller 41B receives a CAN frame from a CAN controller 31 in the relay IC 30, acquires the data stored in the DAT field of the received CAN frame, and outputs received frame information indicating the acquired data to the detection unit 42. The CAN controller 41B suspends output of the CAN frame to the in-vehicle ECUs 111 until the CAN controller 41B receives notification of the determination result from the detection unit 42.

For example, the detection unit 42 compares the value of the data indicated by the received frame information received from the CAN controller 41B with the numerical value range indicated by the numerical value list in the storage unit 44.

If the value of the data indicated by the received frame information received from the CAN controller 41B is within the numerical value range indicated by the numerical value list, the detection unit 42 determines that the CAN frame received by the CAN controller 41B from the CAN controller 31 is not an unauthorized frame, and notifies the CAN controller 41B of the determination result.

If the CAN controller 41B receives notification from the detection unit 42 of the determination result that the CAN frame is not an unauthorized frame, the CAN controller 41B outputs the CAN frame, the output of which had been suspended, to the in-vehicle ECUs 111 via the communication unit 20, the communication ports 10, and the buses 1.

On the other hand, if the value of the data indicated by the received frame information received from the CAN controller 41B is not included in the numerical range indicated by the numerical list, the detection unit 42 determines that the CAN frame received by the CAN controller 41B from the CAN controller 31 is an unauthorized frame, and notifies the CAN controller 41B of the determination result.

If the CAN controller 41B receives notification from the detection unit 42 of the determination result that the CAN frame is an unauthorized frame, the CAN controller 41B discards the CAN frame, the output of which had been suspended, without outputting the CAN frame to the in-vehicle ECUs 111.

### Timing Chart

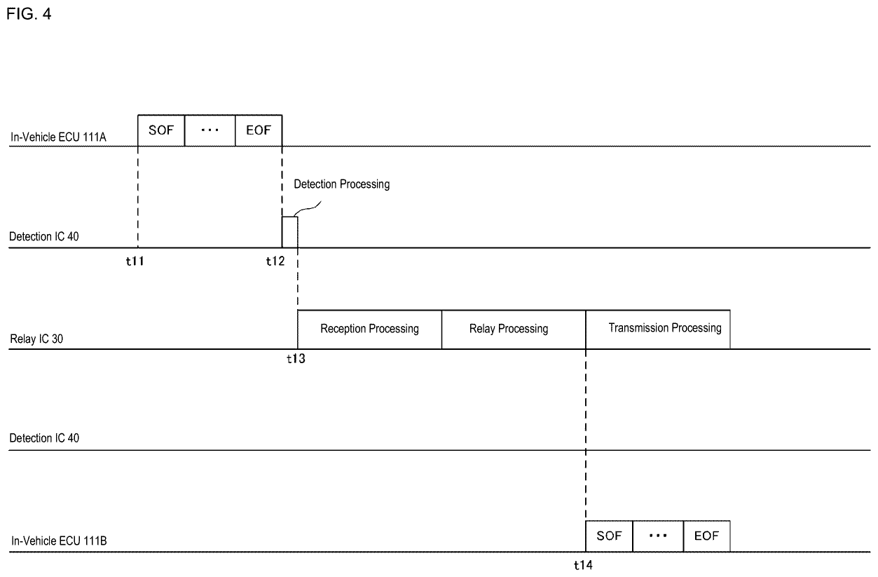

FIG. 4 is a diagram illustrating an example of a timing chart of relay processing in the in-vehicle communication system according to the embodiment of the present disclosure. FIG. 4 shows a timing chart for when the detection IC 40 performs the above-mentioned Example 1 of detection processing.

Referring to FIG. 4, for example, an in-vehicle ECU 111A transmits a CAN frame to the other in-vehicle ECUs 111A and the in-vehicle relay device 101 via the bus 1A at time t11.

At time t11, the detection IC 40 detects the beginning of a CAN frame by receiving the SOF in the CAN frame from the CAN transceiver 21A in the communication unit 20, and starts processing for acquiring the CAN frame. Then, at time t12 after time t11, the detection IC 40 receives the EOF in the CAN frame received from the CAN transceiver 21A, determines that the processing for acquiring the CAN frame is complete, and performs detection processing for determining whether or not the acquired CAN frame is an unauthorized frame. For example, the detection IC 40 determines that the CAN frame is not an unauthorized frame, and outputs the CAN frame to the relay IC 30 at time t13 after time t12.

The relay IC 30 starts the reception processing at time t13, and performs the relay processing after the reception processing. The relay IC 30 starts the transmission processing at time t14 after time t13.

At time t14, the in-vehicle ECUs 111B receive the CAN frame from the in-vehicle relay device 101 via the bus 1B.

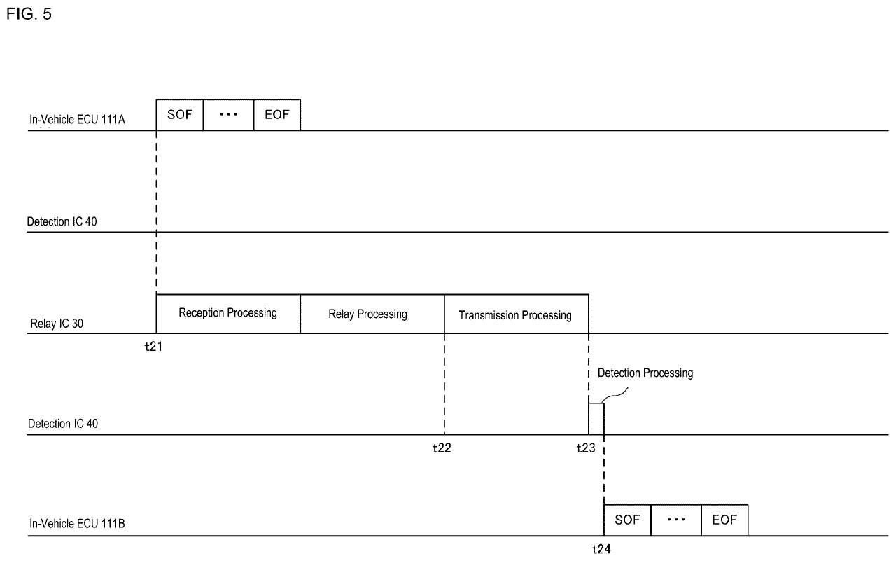

FIG. 5 is a diagram illustrating another example of a timing chart of relay processing in the in-vehicle communication system according to the embodiment of the present disclosure. FIG. 5 shows a timing chart for when the detection IC 40 performs the above-mentioned Example 2 of detection processing.

Referring to FIG. 5, for example, an in-vehicle ECU 111A transmits a CAN frame to the other in-vehicle ECUs 111A and the in-vehicle relay device 101 via the bus 1A at time t21.

The relay IC 30 starts reception processing at time t21, and performs relay processing after the reception processing. The relay IC 30 starts transmission processing at time t22 after time t21.

At time t22, the detection IC 40 detects the beginning of the CAN frame by receiving the SOF in the CAN frame received from the CAN controller 31B in the relay IC 30, and starts processing for acquiring the CAN frame. Then, at time t23 after time t22, the detection IC 40 receives the EOF in the CAN frame received from the CAN controller 31B, determines that the processing for acquiring the CAN frame is complete, and performs detection processing for determining whether or not the acquired CAN frame is an unauthorized frame. For example, the detection IC 40 determines that the CAN frame is not an unauthorized frame, and outputs the CAN frame to the communication unit 20 at time t24 after time t23.

At time t24, the in-vehicle ECUs 111B receive the CAN frame from the in-vehicle relay device 101 via the bus 1B.

### Operation Flow

Each device in the in-vehicle communication system according to the embodiment of the present disclosure includes a computer including a memory, and an arithmetic processing unit such as a CPU in the computer reads out from the memory and executes a program including some or all of the steps of the following flowcharts and sequences. The programs for these multiple devices can each be installed from the outside. The programs for these multiple devices are distributed while stored on a recording medium or are distributed via a communication line.

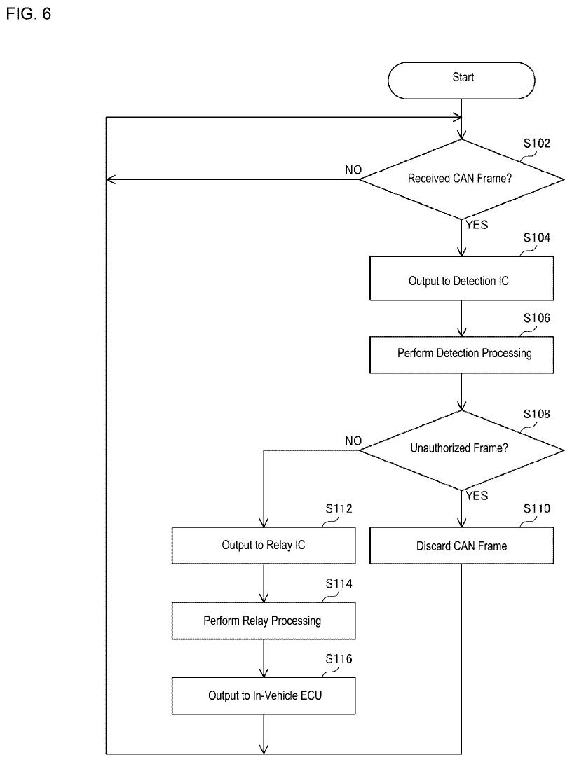

FIG. 6 is a flowchart defining an example of an operation procedure for when the in-vehicle relay device according to the embodiment of the present disclosure performs relay processing and detection processing. FIG. 6 shows a flowchart for when the detection IC 40 performs the above-mentioned Example 1 of detection processing.

Referring to FIG. 6, first, the communication unit 20 in the in-vehicle relay device 101 waits for a CAN frame from an in-vehicle ECU 111A or an in-vehicle ECU 111B (NO in step S102), and upon receiving a CAN frame from an in-vehicle ECU 111A, for example, via the communication port 10A (YES in step S102), the in-vehicle relay device 101 outputs the received CAN frame to the detection IC 40 (step S104).

Next, the detection IC 40 receives the CAN frame from the communication unit 20 and performs detection processing for determining whether or not the received CAN frame is an unauthorized frame (step S106).

Next, if the detection IC 40 determines that the CAN frame received from the communication unit 20 is an unauthorized frame (YES in step S108), the detection IC 40 discards the CAN frame (step S110).

Next, the communication unit 20 waits for a new CAN frame from an in-vehicle ECU 111A or an in-vehicle ECU 111B (NO in step S102).

On the other hand, if the detection IC 40 determines that the CAN frame received from the communication unit 20 is not an unauthorized frame (NO in step S108), the detection IC 40 outputs the CAN frame to the relay IC 30 (step S112).

Next, the relay IC 30 performs relay processing of the CAN frame received from the detection IC 40. Specifically, the relay unit 32 in the relay IC 30 outputs the frame to the detection IC 40 via the CAN controller 31B (step S114).

Next, the detection IC 40 outputs the CAN frame received from the relay IC 30 to the in-vehicle ECUs 111B. More specifically, the CAN controller 41B in the detection IC 40 receives the CAN frame from the CAN controller 31B in the relay IC 30, and outputs the received CAN frame to the in-vehicle ECUs 111B via the communication unit 20, the communication port 10B, and the bus 1B (step S116).

Next, the communication unit 20 waits for a new CAN frame from an in-vehicle ECU 111A or an in-vehicle ECU 111B (NO in step S102).

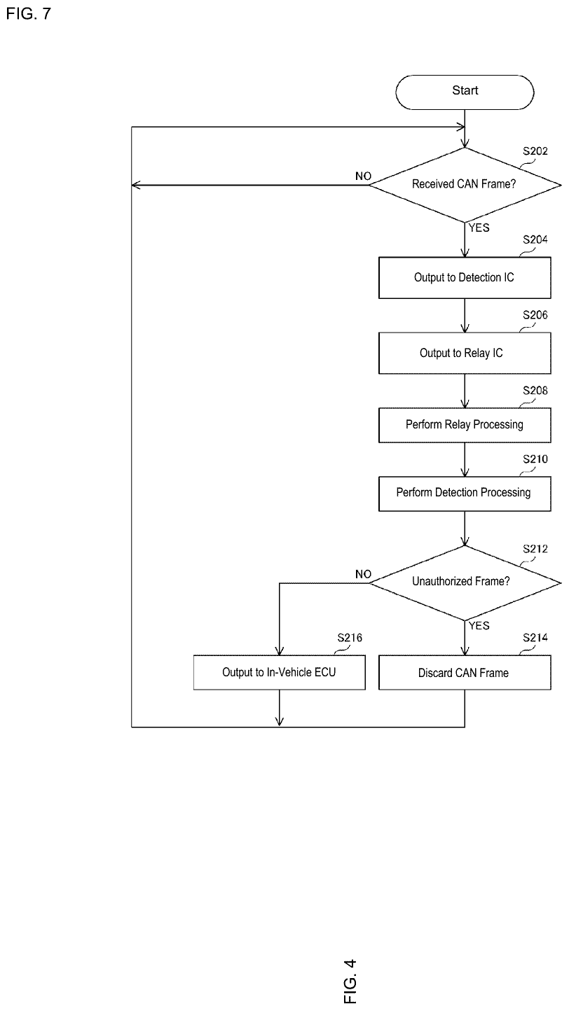

FIG. 7 is a flowchart defining another example of an operation procedure for when the in-vehicle relay device according to the embodiment of the present disclosure performs relay processing and detection processing. FIG. 7 shows a flowchart for when the detection IC 40 performs the above-mentioned Example 2 of detection processing.

Referring to FIG. 7, first, the communication unit 20 in the in-vehicle relay device 101 waits for a CAN frame from an in-vehicle ECU 111A or an in-vehicle ECU 111B (NO in step S202), and upon receiving a CAN frame from an in-vehicle ECU 111A, for example, via the communication port 10A (YES in step S202), the communication unit 20 outputs the received CAN frame to the detection IC 40 (step S204).

Next, the detection IC 40 outputs the CAN frame received from the communication unit 20 to the relay IC 30 (step S206).

Next, the relay IC 30 performs relay processing of the CAN frame received from the detection IC 40. Specifically, the relay unit 32 in the relay IC 30 outputs the frame to the detection IC 40 via the CAN controller 31B (step S208).

Next, the detection IC 40 receives the CAN frame from the relay IC 30 and performs detection processing for determining whether or not the received CAN frame is an unauthorized frame (step S210).

Next, if the detection IC 40 determines that the CAN frame received from the relay IC 30 is an unauthorized frame (YES in step S212), the detection IC 40 discards the CAN frame (step S214).

On the other hand, if the detection IC 40 determines that the CAN frame received from the relay IC 30 is not an unauthorized frame (NO in step S212), the detection IC 40 outputs the CAN frame to the in-vehicle ECUs 111B. More specifically, the CAN controller 41B in the detection IC 40 outputs the CAN frame to the in-vehicle ECUs 111B via the communication unit 20, the communication port 10B, and the bus 1B (step S216).

Next, the communication unit 20 waits for a new CAN frame from an in-vehicle ECU 111A or an in-vehicle ECU 111B (NO in step S202).

Note that in the in-vehicle relay device 101 according to the embodiment of the present disclosure, the relay IC 30 is a processor and the detection IC 40 is a PLD, but there is no limitation to this. For example, the relay IC 30 may also be a PLD. Also, for example, the detection IC 40 may be a processor.

Also, in the in-vehicle relay device 101 according to the embodiment of the present disclosure, the detection IC 40 is configured to monitor CAN frames received by the communication unit 20 via the communication port 10A and monitor CAN frames received by the communication unit 20 via the communication port 10B, but there is no limitation to this. The detection IC 40 may be configured not to monitor either the CAN frames received by the communication unit 20 via the communication port 10A or the CAN frames received by the communication unit 20 via the communication port 10B.

Also, in the in-vehicle communication system 301 according to the embodiment of the present disclosure, the in-vehicle ECUs 111A and 111B are respectively connected to the in-vehicle relay device 101 via the buses 1A and 1B conforming to the CAN standard, but there is no limitation to this. The in-vehicle ECUs 111A and the in-vehicle ECUs 111B may also be connected to the in-vehicle relay device 101 via buses conforming to a standard other than CAN.

For example, the in-vehicle ECUs 111A and the in-vehicle ECUs 111B may also be connected to the in-vehicle relay device 101 via buses conforming to a CAN FD standard. In this case, the communication unit 20 in the in-vehicle relay device 101 includes CAN FD transceivers instead of the CAN transceivers 21, the relay IC 30 includes CAN FD controllers instead of the CAN controllers 31, and the detection IC 40 includes CAN FD controllers instead of the CAN controllers 41.

Also, for example, the in-vehicle ECUs 111A and the in-vehicle ECUs 111B may be respectively connected to the in-vehicle relay device 101 via buses conforming to the LIN (Local Interconnect Network) standard. In this case, the communication unit 20 in the in-vehicle relay device 101 includes LIN transceivers instead of the CAN transceivers 21, the relay IC 30 includes LIN controllers instead of the CAN controllers 31, and the detection IC 40 includes LIN controller instead of the CAN controllers 41.

Also, for example, the in-vehicle ECUs 111A and the in-vehicle ECUs 111B may be respectively connected to the in-vehicle relay device 101 via buses conforming to the CXPI (Clock Extension Peripheral Interface) standard. In this case, the communication unit 20 in the in-vehicle relay device 101 includes CXPI transceivers instead of the CAN transceivers 21, the relay IC 30 includes CXPI controllers instead of the CAN controllers 31, and the detection IC 40 includes CXPI controllers instead of the CAN controllers 41.

Also, the in-vehicle communication system 301 according to the embodiment of the present disclosure may be configured to include in-vehicle ECUs that are each connected to the in-vehicle relay device 101 via buses that comply with different standards.

### Variation 1

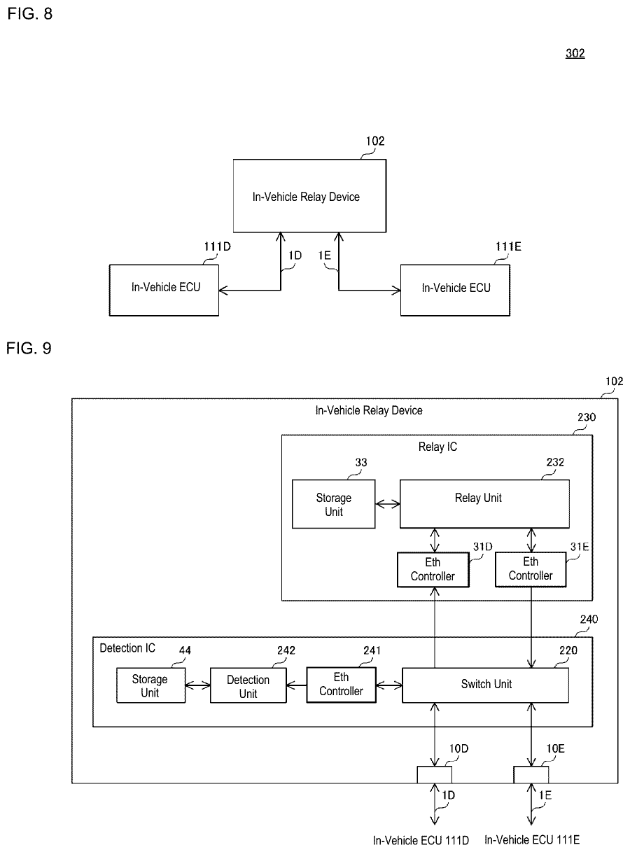

FIG. 8 is a diagram illustrating a configuration of an in-vehicle communication system according to Variation 1 of the embodiment of the present disclosure. Referring to FIG. 8, compared to the in-vehicle communication system 301, an in-vehicle communication system 302 includes an in-vehicle relay device 102 instead of the in-vehicle relay device 101, and includes in-vehicle ECUs 111D and 111E instead of the plurality of in-vehicle ECUs 111A and the plurality of in-vehicle ECUs 111B. The in-vehicle ECUs 111D and 111E are examples of in-vehicle devices.

The in-vehicle ECUs 111D and 111E are connected to the in-vehicle relay device 102 via Ethernet (registered trademark) cables (hereinafter also referred to as Eth cables) 1D and 1E, respectively. The in-vehicle ECU 111D periodically or irregularly generates Ethernet frames (hereinafter also referred to as an Eth frame) in which data to be transmitted to the in-vehicle ECU 111E is stored, and transmits the generated Eth frames to the in-vehicle relay device 102 via the Eth cable 1D. The in-vehicle ECU 111E periodically or irregularly generates Eth frames in which data to be transmitted to the in-vehicle ECU 111D is stored, and transmits the generated Eth frames to the in-vehicle relay device 102 via the Eth cable 1E.

Note that the in-vehicle communication system 302 may be configured to include three or more in-vehicle ECUs connected to the in-vehicle relay device 102 via Eth cables, or may be configured to further include an in-vehicle ECU connected to the in-vehicle relay device 102 via a bus or cable conforming to a standard other than Ethernet.

FIG. 9 is a diagram illustrating a configuration of an in-vehicle relay device according to Variation 1 of the embodiment of the present disclosure. Referring to FIG. 9, compared to the in-vehicle relay device 101, the in-vehicle relay device 102 has communication ports 10D and 10E instead of the communication ports 10A and 10B, a relay IC 230 instead of the relay IC 30, and a detection IC 240 instead of the detection IC 40. The Eth cable 1D is connected to the communication port 10D. The Eth cable 1E is connected to the communication port 10E.

Compared to the relay IC 30, the relay IC 230 includes Ethernet controllers (hereinafter also referred to as Eth controllers) 31D and 31E instead of the CAN controllers 31A and 31B, and includes a relay unit 232 instead of the relay unit 32. Compared to the detection IC 40, the detection IC 240 includes an Eth controller 241 instead of the CAN controllers 41A and 41B, and includes a detection unit 242 instead of the detection unit 42.

### Example 3 of Detection Processing

For example, the switch unit 220 receives an Eth frame from the in-vehicle ECU 111D via the corresponding communication port 10D, and outputs the received Eth frame to the Eth controller 241.

The Eth controller 241 acquires information stored in the Eth frame received by the switch unit 220. For example, the Eth controller 241 detects the beginning of the Eth frame received from the switch unit 220 by receiving a header, such as a preamble, in the Eth frame, acquires information stored in at least one field in the Eth frame, and outputs the obtained information to the detection unit 242. As an example, the Eth controller 241 acquires information stored in a length field in the Eth frame, and outputs the acquired information to the detection unit 242. The Eth controller 241 suspends output of the Eth frame to the relay IC 230 until notification of the determination result is received from the detection unit 242.

The detection unit 242 performs detection processing based on the information received from the Eth controller 241. More specifically, the detection unit 242 determines whether or not the Eth frame received by the switch unit 220 is an unauthorized frame based on the received information, and notifies the Eth controller 241 of the determination result.

If the Eth controller 241 receives notification from the detection unit 242 of the determination result that the Eth frame is an unauthorized frame, the Eth controller 241 discards the Eth frame, the output of which had been suspended, without outputting the Eth frame to the relay IC 230.

On the other hand, if the Eth controller 241 receives notification from the detection unit 242 of the determination result that the Eth frame is not an unauthorized frame, the Eth controller 241 outputs the Eth frame, the output of which had been withheld, to the relay IC 30 via the switch unit 220.

The Eth controller 31D in the relay IC 230 outputs the Eth frame received from the detection IC 240 via the switch unit 220 to the relay unit 232.

The relay unit 232 receives the Eth frame from the Eth controller 31D, performs reception checking processing for checking the content of the received Eth frame, and if the reception checking processing is complete, performs relay processing of the Eth frame to be relayed. Specifically, the relay unit 232 outputs the Eth frame to be relayed that was received from the Eth controller 31D, to the Eth controller 31E.

The Eth controller 31E receives the Eth frame from the relay unit 232 and outputs the received Eth frame to the switch unit 220.

The switch unit 220 receives the Eth frame from the Eth controller 31E and transmits the received Eth frame to the in-vehicle ECU 111E that is the destination via the corresponding communication port 10E and Eth cable 1E.

### Example 4 of Detection Processing

For example, the switch unit 220 receives an Eth frame from the in-vehicle ECU 111D via the corresponding communication port 10D, and outputs the received Eth frame to the relay IC 230.

The Eth controller 31D in the relay IC 230 outputs the Eth frame received from the detection IC 240 via the switch unit 220 to the relay unit 232.

The relay unit 232 outputs the Eth frame to be relayed that was received from the Eth controller 31D to the Eth controller 31E.

The Eth controller 31E receives the Eth frame from the relay unit 232 and outputs the received Eth frame to the switch unit 220.

The switch unit 220 receives the Eth frame from the Eth controller 31E and outputs the received Eth frame to the Eth controller 241.

The Eth controller 241 acquires information stored in the Eth frame received by the switch unit 220. For example, the Eth controller 241 detects the beginning of the Eth frame received from the switch unit 220 by receiving a header, such as a preamble, in the Eth frame, acquires information stored in at least one field in the Eth frame, and outputs the acquired information to the detection unit 242. As an example, the Eth controller 241 acquires information stored in a length field in the Eth frame and outputs the acquired information to the detection unit 242. The Eth controller 241 suspends output of the Eth frame to the in-vehicle ECU 111E until notification of the determination result is received from the detection unit 242.

The detection unit 242 performs detection processing based on the information received from the Eth controller 241. More specifically, the detection unit 242 determines whether or not the Eth frame received by the switch unit 220 is an unauthorized frame based on the received information, and notifies the Eth controller 241 of the determination result.

If the Eth controller 241 receives notification from the detection unit 242 of the determination result that the Eth frame is an unauthorized frame, the Eth controller 241 discards the Eth frame, the output of which had been suspended, without outputting the Eth frame to the in-vehicle ECU 111E.

On the other hand, if the Eth controller 241 receives notification from the detection unit 242 of the determination result that the Eth frame is not an unauthorized frame, the Eth controller 241 transmits the Eth frame, the output of which had been suspended, to the in-vehicle ECU 111E via the switch unit 220, the communication port 10E, and the Eth cable 1E.

### Variation 2

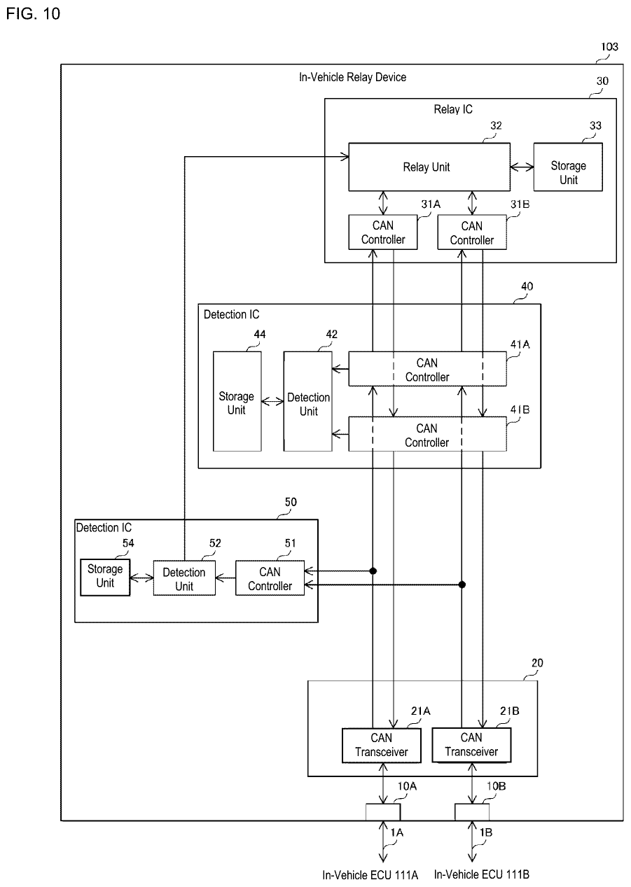

FIG. 10 is a diagram illustrating a configuration of an in-vehicle communication system according to Variation 2 of the embodiment of the present disclosure. Referring to FIG. 10, the in-vehicle relay device 103 further includes a detection IC 50 in comparison with the in-vehicle relay device 101. The detection IC 50 is an example of a third IC.

The detection IC 50 includes a CAN controller 51, a detection unit 52, and a storage unit 54. The storage unit 54 is, for example, a non-volatile memory. For example, similarly to the storage unit 44, the storage unit 54 stores an ID list, a DLC list, and a numerical value list. The detection IC 50, similarly to the detection IC 40, has a circuit including a PLD.

In the communication unit 20, the CAN transceiver 21A receives a CAN frame from the in-vehicle ECU 111A via the communication port 10A. The CAN transceiver 21A outputs the received CAN frame to the detection ICs 40 and 50. Also, the CAN transceiver 21B receives a CAN frame from the in-vehicle ECU 111B via the communication port 10B. The CAN transceiver 21B outputs the received CAN frame to the detection ICs 40 and 50.

For example, the CAN transceiver 21 outputs the received CAN frame to the detection ICs 40 and 50. That is, the CAN frame is output from the CAN transceiver 21 to the relay IC 30 and the detection IC 40 in parallel.

The detection IC 50 monitors the CAN frame and performs detection processing for determining whether or not the CAN frame is an unauthorized frame. More specifically, the CAN controller 51 receives a CAN frame from a CAN transceiver 21 in the communication unit 20, obtains the ID and the like stored in the ID field of the received CAN frame, and outputs the received frame information to the detection unit 52. The detection unit 52 performs detection processing based on the received frame information received from the CAN controller 51, similarly to the detection unit 42. The detection processing performed by the detection IC 50 corresponds to the function of an IDS, for example.

For example, the detection IC 50 performs detection processing based on the ID stored in the ID field of the CAN frame. Also, for example, the detection IC 40 performs detection processing based on the DLC stored in the DLC field of the CAN frame.

If the detection IC 50 determines that the CAN frame is an unauthorized frame, the detection IC 50 notifies the relay IC 30 of a detection result indicating that an unauthorized frame has been detected. More specifically, if the detection unit 52 determines that the CAN frame received by the CAN controller 51 from the CAN transceiver 21 is an unauthorized frame, the detection unit 52 outputs, as a detection result, unauthorized detection information indicating the ID of the unauthorized frame to the relay IC 30 through communication using, for example, a Universal Asynchronous Receiver Transmitter (UART). On the other hand, if the detection unit 52 determines that the CAN frame received by the CAN controller 51 from the CAN transceiver 21 is not an unauthorized frame, the detection unit 52 outputs normal detection information as a detection result to the relay IC 30 through communication using UART. The notification of the detection result by the detection IC 50 corresponds to the function of, for example, an IPS.

For example, the relay IC 30 stops the relay processing of the unauthorized frame based on the detection result notified from the detection IC 50. More specifically, if the relay unit 32 in the relay IC 30 receives unauthorized detection information from the detection unit 52, the relay unit 32 stores the ID indicated in the received unauthorized detection information in the storage unit 33 as the ID of the unauthorized frame. On the other hand, if the relay unit 32 receives normal detection information from the detection unit 52, the relay unit 32 does not store the ID in the storage unit 33.

The relay unit 32 receives a CAN frame from the CAN controller 31A and checks whether or not the ID included in the ID field of the received CAN frame matches the ID of the unauthorized frame in the storage unit 33.

If the ID included in the ID field of the CAN frame received from the CAN controller 31A does not match the ID of the unauthorized frame in the storage unit 33, or if the ID of the unauthorized frame has not been stored in the storage unit 33, the relay unit 32 determines that the CAN frame received from the CAN controller 31A is an authorized CAN frame and performs relay processing of the CAN frame.

On the other hand, if the ID included in the ID field of the CAN frame received from the CAN controller 31A matches the ID of an unauthorized frame in the storage unit 33, the relay unit 32 determines that the CAN frame received from the CAN controller 31A is an unauthorized frame and discards the CAN frame without performing relay processing of the CAN frame.

In this way, since the in-vehicle relay device 103 is configured to include the detection ICs 40 and 50, the detection IC 40 can suspend output of the frame to the relay IC 30, and therefore compared to a configuration in which the in-vehicle relay device 103 includes only the detection IC 50, no special processing such as suspending output of the CAN frame is required, because the detection result from the detection IC 50 is used to determine whether or not to perform relay processing of the CAN frame in the relay IC 30. Accordingly, an existing IC can be used as the relay IC 30.

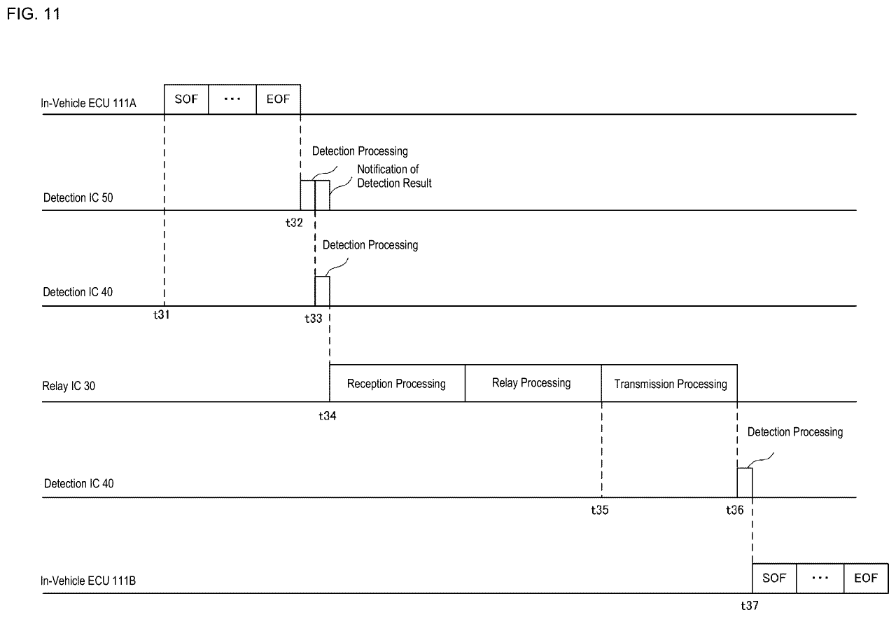

FIG. 11 is a diagram illustrating an example of a timing chart of relay processing performed in an in-vehicle communication system according to Variation 2 of the embodiment of the present disclosure. FIG. 11 shows a timing chart for when the detection IC 40 performs both the above-mentioned Example 1 of detection processing and Example 2 of detection processing.

Referring to FIG. 11, for example, an in-vehicle ECU 111A transmits a CAN frame to the other in-vehicle ECUs 111A and the in-vehicle relay device 101 via the bus 1A at time t31.

At time t31, the detection IC 50 detects the beginning of the CAN frame by receiving the SOF in the CAN frame from the CAN transceiver 21A in the communication unit 20, and starts the processing for acquiring the CAN frame. Then, at time t32 after time t31, the detection IC 50 receives the EOF in the CAN frame received from the CAN transceiver 21A, determines that the acquisition processing of the CAN frame is complete, and performs detection processing for determining whether or not the CAN frame is an unauthorized frame based on the ID of the acquired CAN frame. For example, the detection IC 50 determines that the CAN frame is not an unauthorized frame, and outputs normal detection information to the relay IC 30 as the detection result.

At time t31, the detection IC 40 detects the beginning of the CAN frame by receiving the SOF in the CAN frame from the CAN transceiver 21A in the communication unit 20, and starts the processing for acquiring the CAN frame. Then, at time t33 after time t31, the detection IC 40 receives the EOF in the CAN frame received from the CAN transceiver 21A, determines that the acquisition processing of the CAN frame is complete, and performs detection processing for determining whether or not the CAN frame is an unauthorized frame based on the DLC of the acquired CAN frame. For example, the detection IC 40 determines that the CAN frame is not an unauthorized frame, and outputs the CAN frame to the relay IC 30 at time t34 after time t33.

The relay IC 30 starts the reception processing at time t34. Since the ID included in the ID field of the CAN frame received from the CAN controller 31A does not match the ID of the unauthorized frame in the storage unit 33, the relay IC 30 performs relay processing of the CAN frame after the reception processing. Then, the relay IC 30 starts the transmission processing at time t35 after time t34.

At time t35, the detection IC 40 detects the beginning of the CAN frame by receiving the SOF in the CAN frame received from the CAN controller 31B in the relay IC 30, and starts the processing for acquiring the CAN frame. Then, at time t36 after time t35, the detection IC 40 receives an EOF in the CAN frame received from the CAN controller 31B, determines that the processing for acquiring the CAN frame is complete, and performs detection processing for determining whether or not the acquired CAN frame is an unauthorized frame. For example, the detection IC 40 determines that the CAN frame is not an unauthorized frame, and outputs the CAN frame to the communication unit 20 at time t37 after time t36.

At time t37, the in-vehicle ECUs 111B receive the CAN frame from the in-vehicle relay device 101 via the bus 1B.

For example, the detection IC 40 performs detection processing at time t33, and if the detection IC 40 determines that the CAN frame is an unauthorized frame, the detection IC 40 does not output the CAN frame to the relay IC 30 at time t34.

Also, for example, the detection IC 50 performs detection processing at time t32, and if the detection IC 50 determines that the CAN frame is an unauthorized frame, the detection IC 50 outputs unauthorized detection information to the relay IC 30 as a detection result. In this case, the relay IC 30 does not perform relay processing of the CAN frame after the reception processing because the ID included in the ID field of the CAN frame received from the CAN controller 31A matches the ID of the unauthorized frame in the storage unit 33.

Also, for example, the detection IC 40 performs the detection processing at time t36, and if the detection IC 40 determines that the CAN frame is an unauthorized frame, the detection IC 40 does not output the CAN frame to the communication unit 20 at time t37.

With a configuration in which the detection IC 50 performs detection processing based on the ID and the detection IC 40 performs detection processing based on the DLC, for example, the detection IC 50 can complete detection processing faster than the detection IC 40, and therefore the detection result regarding the CAN frame can be notified to the relay IC 30 before the relay IC 30 receives the CAN frame from the detection IC 40 and performs relay processing. This allows the relay IC 30 to determine whether or not to relay the CAN frame with consideration given to the detection result in the detection IC 50.

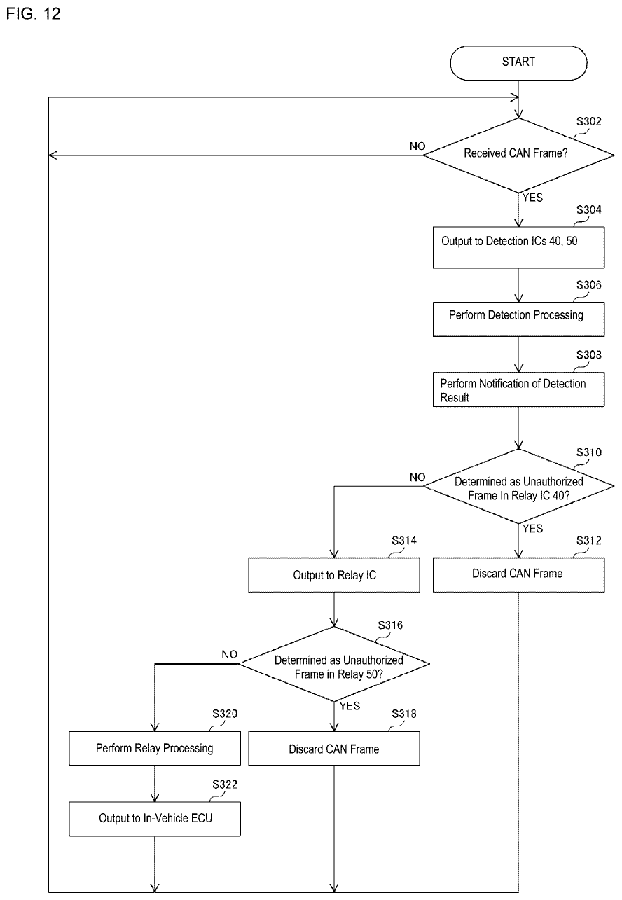

FIG. 12 is a flowchart defining an example of an operation procedure for when the in-vehicle relay device according to Variation 2 of the embodiment of the present disclosure performs relay processing and detection processing.

Referring to FIG. 12, first, the communication unit 20 in the in-vehicle relay device 101 waits for a CAN frame from an in-vehicle ECU 111A or an in-vehicle ECU 111B (NO in step S302), and upon receiving a CAN frame from an in-vehicle ECU 111A, for example, via the communication port 10A (YES in step S302), the communication unit 20 outputs the received CAN frame to the detection ICs 40 and 50 (step S304).

Next, the detection ICs 40 and 50 receive the CAN frame from the communication unit 20 and perform detection processing for determining whether or not the received CAN frame is an unauthorized frame (step S306).

Next, the detection IC 50 notifies the relay IC 30 of the detection result (step S308).

Next, if the detection IC 40 determines that the CAN frame received from the communication unit 20 is an unauthorized frame (YES in step S310), the detection IC 40 discards the CAN frame (step S312).

Next, the communication unit 20 waits for a new CAN frame from an in-vehicle ECU 111A or an in-vehicle ECU 111B (NO in step S302).

On the other hand, if the detection IC 40 determines that the CAN frame received from the communication unit 20 is not an unauthorized frame (NO in step S310), the detection IC 40 outputs the CAN frame to the relay IC 30 (step S314).

Next, if the detection result received from the detection IC 50 indicates that the CAN frame received from the detection IC 40 is an unauthorized frame (YES in step S316), the relay IC 30 discards the CAN frame without relaying it (step S318).

Next, the communication unit 20 waits for a new CAN frame from an in-vehicle ECU 111A or an in-vehicle ECU 111B (NO in step S302).

On the other hand, if the detection result received from the detection IC 50 indicates that the CAN frame received from the detection IC 40 is not an unauthorized frame (NO in step S316), the relay IC 30 performs relay processing of the CAN frame received from the detection IC 40. Specifically, the relay unit 32 in the relay IC 30 outputs the frame to the detection IC 40 via the CAN controller 31B (step S320).

Next, the detection IC 40 outputs the CAN frame received from the relay IC 30 to the in-vehicle ECU 111B. More specifically, the CAN controller 41B in the detection IC 40 receives the CAN frame from the CAN controller 31B in the relay IC 30 and outputs the received CAN frame to the in-vehicle ECUs 111B via the communication unit 20, the communication port 10B, and the bus 1B (step S322).

Next, the communication unit 20 waits for a new CAN frame from an in-vehicle ECU 111A or an in-vehicle ECU 111B (NO in step S302).

The above-described embodiments should be considered as illustrative in all respects and not limiting. The scope of the present disclosure is defined not by the above description but by the claims, and is intended to encompass all modifications within the meaning and range of equivalence to the claims.

The above description includes the following additional features.

An in-vehicle relay device includes a reception unit configured to receive a frame from an in-vehicle device; a first IC (Integrated Circuit) configured to perform relay processing of the frame received from the reception unit; and a second IC that is connected between the reception unit and the first IC and is configured to output the frame received from the reception unit to the first IC and output the frame received from the first IC to the outside of the in-vehicle device. The second IC monitors the frame and stops output of the frame if the second IC determines that the frame is an unauthorized frame. The in-vehicle relay device further includes a third IC configured to monitor the frame received by the reception unit, and if it is determined that the frame is an unauthorized frame, notify the first IC of a detection result indicating that the unauthorized frame has been detected. The first IC stops the relay processing of the unauthorized frame based on the detection result notified from the third IC. The third IC performs detection processing based on an ID stored in an ID field of the frame, and the second IC performs detection processing based on a DLC stored in a DLC field of the frame.

1. An in-vehicle relay device, comprising:
a reception unit configured to receive a frame from an in-vehicle device;
a first IC (Integrated Circuit) configured to perform relay processing of the frame received from the reception unit; and
a second IC that is connected between the reception unit and the first IC and is configured to output the frame received from the reception unit to the first IC and output the frame received from the first IC to the outside of the in-vehicle device,
wherein the second IC monitors the frame and stops output of the frame if the second IC determines that the frame is an unauthorized frame.

2. The in-vehicle relay device according to claim 1, wherein the second IC monitors the frame received from the reception unit and stops output of the frame to the first IC if the second IC determines that the frame is an unauthorized frame.

3. The in-vehicle relay device according to claim 1, wherein the second IC monitors the frame received from the first IC and stops output of the frame to the outside of the in-vehicle relay device if the second IC determines that the frame is an unauthorized frame.

4. The in-vehicle relay device according to claim 1, wherein the first IC is a processor, and
the second IC has a circuit including a PLD (Programmable Logic Device).

5. The in-vehicle relay device according to claim 4, wherein the second IC has a circuit including an FPGA (Field Programmable Gate Array).

6. The in-vehicle relay device according to claim 1, further including:
a plurality of communication ports,
wherein the first IC performs the relay processing of a plurality of the frames received by the reception unit via the respective plurality of communication ports, and
the second IC monitors the plurality of frames received by the reception unit via the respective plurality of communication ports.

7. The in-vehicle relay device according to claim 1, wherein the reception unit receives the frame conforming to a CAN (Controller Area Network) or a CAN FD (CAN with Flexible Data rate) standard and outputs the received frame to the second IC, and
the second IC performs determination of the unauthorized frame based on an ID (Identifier) stored in the frame.

8. The in-vehicle relay device according to claim 1, wherein the reception unit receives the frame conforming to a CAN or a CAN FD standard and outputs the received frame to the second IC, and
the second IC performs determination of the unauthorized frame based on a DLC (Data Length Code) stored in the frame.

9. The in-vehicle relay device according to claim 1, further comprising
a third IC configured to monitor the frame received by the reception unit, and if the third IC determines that the frame is an unauthorized frame, notify the first IC of a detection result indicating that the unauthorized frame has been detected,
wherein the first IC stops the relay processing of the unauthorized frame based on the detection result notified from the third IC.

10. An in-vehicle relay method for an in-vehicle relay device including a reception unit, a first IC configured to perform relay processing of a frame received by the reception unit, and a second IC that is connected between the reception unit and the first IC and is configured to output the frame received from the reception unit to the first IC and output the frame received from the first IC to the outside of the in-vehicle relay device, the in-vehicle relay method comprising:
a step of receiving a frame from an in-vehicle device; and
a step of the second IC monitoring the frame and stopping output of the frame if the second IC determines that the frame is an unauthorized frame.

11. An in-vehicle relay program to be used in an in-vehicle relay device configured to receive a frame from an in-vehicle device, the program being for causing a computer to function as:
a reception unit configured to receive a frame from an in-vehicle device;
a first IC configured to perform relay processing of the frame received from the reception unit; and
a second IC that is connected between the reception unit and the first IC and is configured to output the frame received from the reception unit to the first IC and output the frame received from the first IC to the outside of the in-vehicle device,
wherein the second IC monitors the frame and stops output of the frame if the second IC determines that the frame is an unauthorized frame.
